(19) United States
(12) Patent Application Publication
(10) Pub. No.: US 2023/0085174 A1
(43) Pub. Date: Mar. 16, 2023

(54) NETWORK-ASSISTED POSITIONING-SIGNAL PROCESSING

(71) Applicant: QUALCOMM Incorporated, San Diego, CA (US)

(72) Inventors: Chandrasekhar JAYARAM, Bangalore (IN); Devyesh TANDON, Mumbai (IN); Santoshkumar ZALAKE, Bengaluru (IN); Srinivas GANGJI, Bangalore (IN)

(21) Appl. No.: 17/801,341

(22) PCT Filed: Feb. 26, 2021
(86) PCT No.: PCT/US2021/019764

§ 371 Date: Aug. 22, 2022

(30) Foreign Application Priority Data
Mar. 2, 2020 (IN) 202041008972

(51) Int. Cl. H04W 4/02; H04W 24/04; G01S 19/46

(52) U.S. Cl. CPC H04W 4/02; H04W 24/04; G01S 19/46

(57) ABSTRACT

A UE includes: a memory; a receiver configured to receive wireless signals; and a processor communicatively coupled to the memory and the receiver and configured to: receive, via the receiver, one or more indications corresponding to one or more failures of a first positioning signal source; disable a first positioning-signal-processing function of the UE for the first positioning signal source based on the one or more indications; and perform a second positioning-signal-processing function of the UE using a positioning signal from the first positioning signal source while the first positioning-signal-processing function of the UE is disabled.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

It is often desirable to know the location of a user equipment (UE), e.g., a cellular phone, with the terms “location” and “position” being synonymous and used interchangeably herein. A location services (LCS) client may desire to know the location of the UE and may communicate with a location center or location server in order to request the location of the UE. The location center/server and the UE may exchange messages, as appropriate, to obtain a location estimate for the UE. The location center/server may return the location estimate to the LCS client, e.g., for use in one or more applications. In general, the location of the UE may be determined by the UE and/or the location center/server based on various factors including the UE capabilities, network capabilities, positioning data sources that are available, applications and/or services that require the location of the UE, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example user equipment (UE) includes: a memory; a receiver configured to receive wireless signals; and a processor communicatively coupled to the memory and the receiver and configured to: receive, via the receiver, one or more indications corresponding to one or more failures of a first positioning signal source; disable a first positioning-signal-processing function of the UE for the first positioning signal source based on the one or more indications; and perform a second positioning-signal-processing function of the UE using a positioning signal from the first positioning signal source while the first positioning-signal-processing function of the UE is disabled.

An example method of controlling processing of positioning signals includes: receiving, at a UE, one or more indications corresponding to one or more failures of a first positioning signal source; disabling a first positioning-signal-processing function of the UE for the first positioning signal source based on the one or more indications; and performing a second positioning-signal-processing function of the UE using a positioning signal from the first positioning signal source while the first positioning-signal-processing function of the UE is disabled.

Another example UE includes: means for receiving one or more indications corresponding to one or more failures of a first positioning signal source; means for disabling a first positioning-signal-processing function of the UE for the first positioning signal source based on the one or more indications; and means for performing a second positioning-signal-processing function of the UE using a positioning signal from the first positioning signal source while the first positioning-signal-processing function of the UE is disabled.

An example non-transitory processor-readable storage medium includes processor-readable instructions configured to cause one or more processors of a UE to: receive one or more indications corresponding to one or more failures of a first positioning signal source; disable a first positioning-signal-processing function of the UE for the first positioning signal source based on the one or more indications; and perform a second positioning-signal-processing function of the UE using a positioning signal from the first positioning signal source while the first positioning-signal-processing function of the UE is disabled.

An example apparatus for controlling processing of positioning signals includes: a transmitter; and a processor communicatively coupled to the transmitter and configured to: determine one or more failures of a positioning signal source; determine a first positioning-signal-processing function, of a UE, negatively affected by the one or more failures of the positioning signal source, the UE being configured to perform the first positioning-signal-processing function and at least a second positioning-signal-processing function; and send, via the transmitter, an indication to the UE to cause the UE to disable only the first positioning-signal-processing function for the positioning signal source from among the first positioning-signal-processing function and the second positioning-signal-processing function.

An example method of controlling processing of positioning signals includes: determining one or more failures of a positioning signal source; determining a first positioning-signal-processing function, of a UE, negatively affected by the one or more failures of the positioning signal source, the UE being configured to perform the first positioning-signal-processing function and at least a second positioning-signal-processing function; and sending an indication to the UE to cause the UE to disable only the first positioning-signal-processing function for the positioning signal source from among the first positioning-signal-processing function and the second positioning-signal-processing function.

An example apparatus for controlling processing of positioning signals includes: means for determining one or more failures of a positioning signal source; means for determining a first positioning-signal-processing function, of a UE, negatively affected by the one or more failures of the positioning signal source, the UE being configured to perform the first positioning-signal-processing function and at least a second positioning-signal-processing function; and means for sending an indication to the UE to cause the UE to disable only the first positioning-signal-processing function for the positioning signal source from among the first positioning-signal-processing function and the second positioning-signal-processing function.

Another example non-transitory processor-readable storage medium includes processor-readable instructions configured to cause one or more processors to: determine one or more failures of a positioning signal source; determine a first positioning-signal-processing function, of a UE, negatively affected by the one or more failures of the positioning signal source, the UE being configured to perform the first positioning-signal-processing function and at least a second positioning-signal-processing function; and send an indication to the UE to cause the UE to disable only the first positioning-signal-processing function for the positioning signal source from among the first positioning-signal-processing function and the second positioning-signal-processing function.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point shown in FIG. 1.

FIG. 4 is a block diagram of components of an example server shown in FIG. 1.

FIG. 5 is a process flow of signals exchanged between, and operations performed by, components of the system shown in FIG. 1.

FIG. 6 is a functional block diagram of functional components of the user equipment shown in FIG. 2.

FIG. 7 is an example of a failure communication shown in FIG. 5.

FIG. 8 is a block flow diagram of a method of controlling processing of positioning signals.

FIG. 9 is a block flow diagram of another method of controlling processing of positioning signals.

FIG. 10 is a simplified block diagram of a user equipment.

FIG. 11 is a simplified block diagram of an apparatus for controlling processing of positioning signals.

### DETAILED DESCRIPTION

Techniques are discussed herein for coordinating positioning signaling. For example, an apparatus such as a server (or other device such as a Transmission/Reception Point (TRP)) may determine that one or more positioning signal sources such as one or more base stations or one or more satellite vehicles (SVs) in a set of positioning signal sources (e.g., a constellation of positioning signal sources such as of SVs) is(are) experiencing a failure, e.g., transmitting incorrect information, transmitting stale information, failing to transmit (at least some) information, etc. The server may identify one or more functions performed at a user equipment (UE) negatively affected by the failure(s), e.g., one or more functions that will yield unreliable results if the transmitted information is used, or if no (or not all needed) information is received. The server may send an indication of the failure(s) to the UE to cause the UE to disable the negatively-affected function(s). The indication may take a variety of forms such as an indication of poor data being transmitted, an indication of insufficient data being transmitted, and/or an instruction (a command) to disable the negatively-affected function(s). The indication may comprise multiple sub-indications. The UE may respond to the indication by determining the negatively-affected function(s) (e.g., if the indication indicated that poor or insufficient (or no) data are being transmitted), and disabling the appropriate function(s) for processing incoming positioning signals, e.g., for one or more particular positioning signal sources experiencing the failure(s). The UE may disable the negatively-affected function(s) while processing positioning signals to perform other functions. A function may be disabled for processing signals from one signal source while the same function is enabled for processing signals from another signal source. The UE may disable the appropriate negatively-affected function(s) for a limited time, and enable the function(s) (e.g., for the appropriate signal source(s)) after the limited time passes. These techniques and configurations are examples, and other techniques and configurations may be used.

Items and/or techniques described herein may provide one or more of the following capabilities, as well as other capabilities not mentioned. Useful information, e.g., timing information, may be gleaned from positioning signals that are partially flawed, e.g., have some erroneous and/or stale information. Processing of flawed positioning signals and/or flawed positioning signal information may be avoided which may improve positioning accuracy. Processing of positioning signals with finer granularity than “process” or “do not process” may be achieved. Other capabilities may be provided and not every implementation according to the disclosure must provide any, let alone all, of the capabilities discussed.

Obtaining the location of a mobile device that is accessing a wireless network may be useful for many applications including, for example, emergency calls, personal navigation, asset tracking, locating a friend or family member, etc. Existing positioning methods include methods based on measuring radio signals transmitted from a variety of devices or entities including satellite vehicles and terrestrial radio sources in a wireless network such as base stations and access points.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed, and may be alternatively referred to as an Access Point (AP), a Network Node, a NodeB, an evolved NodeB (eNB), a general Node B (gNodeB, gNB), etc. In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

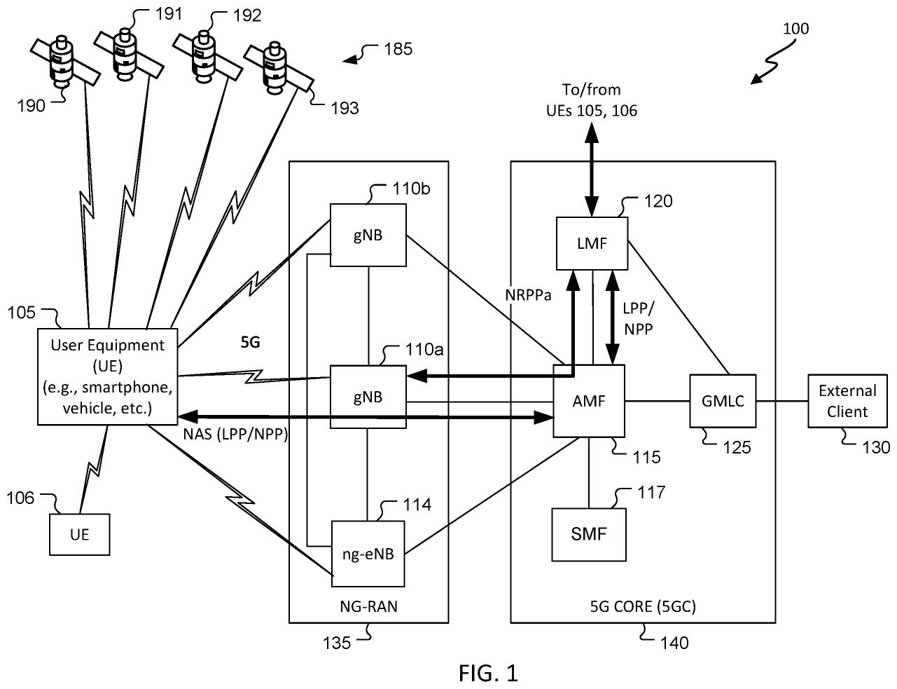

Referring to FIG. 1, an example of a communication system 100 includes a UE 105, a UE 106, a Radio Access Network (RAN) 135, here a Fifth Generation (5G) Next Generation (NG) RAN (NG-RAN), and a 5G Core Network (5GC) 140. The UE 105 and/or the UE 106 may be, e.g., an IoT device, a location tracker device, a cellular telephone, a vehicle (e.g., a car, a truck, a bus, a boat, etc.) or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3^{rd} Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105. The gNBs 110a, 110b, the ng-eNB 114, and/or one or more other base stations may provide positioning signals to the UE 105 that the UE 105 may process to determine a location of the UE 105. While the discussion herein focuses on the SVs 190-193 and positioning signals provided by the SVs 190-193, techniques discussed herein may be applied to other positioning signal sources, e.g., terrestrial-based positioning signal sources such as the base stations 110a, 110b, 114 and/or other base stations. The gNBs 110a, 110b, and the ng-eNB 114 are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. The BSs 110a, 110b, 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more of the BSs 110a, 110b, 114 may be configured to communicate with the UE 105 via multiple carriers. Each of the BSs 110a, 110b, 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although only one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the BSs 110a, 110b, 114 and/or the network 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples only as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the BSs 110a, 110b, 114, the core network 140, and/or the external client 130. For example, such other devices may include internet of thing (IoT) devices, medical devices, home entertainment and/or automation devices, etc. The core network 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The BSs 110a, 110b, 114 may each comprise one or more TRPs. For example, each sector within a cell of a BS may comprise a TRP, although multiple TRPs may share one or more components (e.g., share a processor but have separate antennas). The system 100 may include only macro TRPs or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the BSs 110a, 110b, 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematics (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the core network 140, and may provide QoS (Quality of Service) flow and session management. The AMF 115 may support mobility of the UE 105 including cell change and handover and may participate in supporting signaling connection to the UE 105.

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though only one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

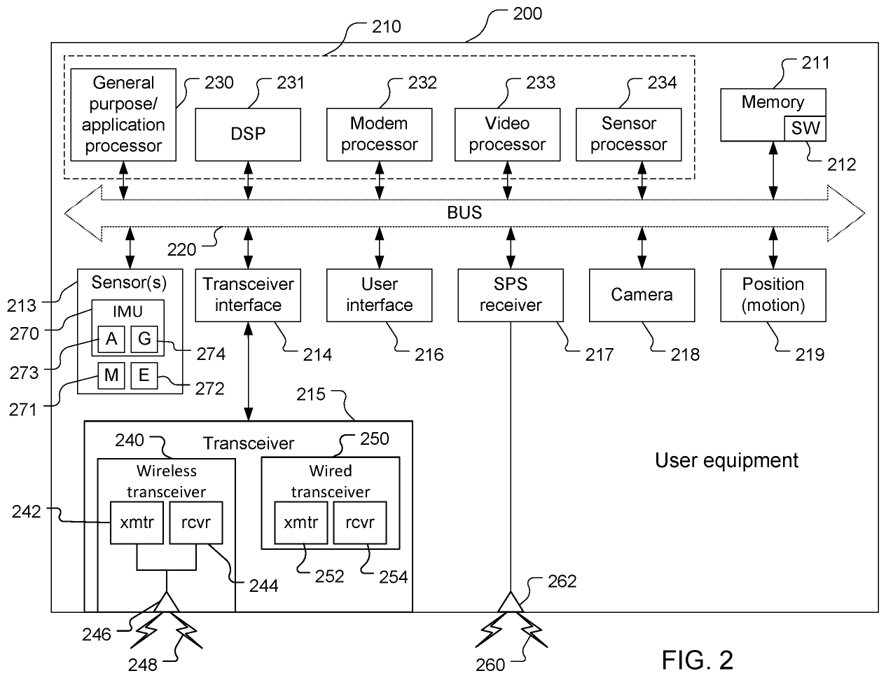

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one o r more cellular wireless signals transmitted and reflection(s) used to identity, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer only to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, the wireless transceiver 240, and one or more of the sensor(s) 213, the user interface 216, the SPS receiver 217, the camera 218, the PD 219, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. The sensor(s) 213 may include a radar system, a lidar system, and/or a sonar system, including one or more antennas as appropriate. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) 271 may include a two-dimensional magnetometer configured to detect and provide indications of magnetic field strength in two orthogonal dimensions. Also or alternatively, the magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to one or more antennas 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., with the network 135 to send communications to, and receive communications from, the gNB 110a, for example. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer only to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general purpose/application processor 230, the transceiver 215, the SPS receiver 262, and/or another component of the UE 200, and may be provided by hardware, software, firmware, or various combinations thereof.

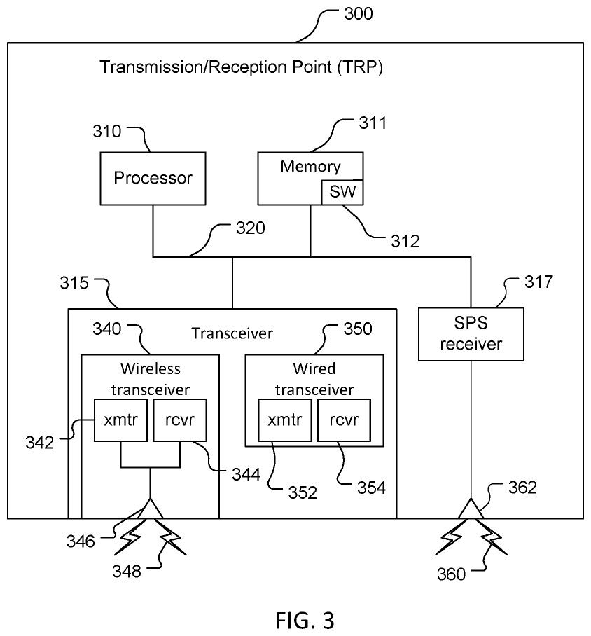

Referring also to FIG. 3, an example of a TRP 300 of the BSs 110a, 110b, 114 comprises a computing platform including a processor 310, memory 311 including software (SW) 312, a transceiver 315, and (optionally) an SPS receiver 317. The processor 310, the memory 311, the transceiver 315, and the SPS receiver 317 may be communicatively coupled to each other by a bus 320 (which may be configured, e.g., for optical and/or electrical communication). One or more of the shown apparatus (e.g., a wireless interface and/or the SPS receiver 317) may be omitted from the TRP 300. The SPS receiver 317 may be configured similarly to the SPS receiver 217 to be capable of receiving and acquiring SPS signals 360 via an SPS antenna 362. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer only to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the BSs 110a, 110b, 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the network 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

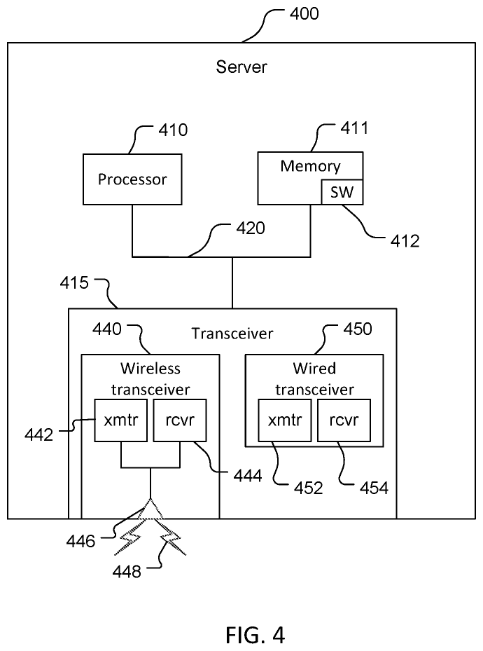

Referring also to FIG. 4, a server 400, which is an example of the LMF 120, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the network 135 to send communications to, and receive communications from, the TRP 300, for example, and/or one or more other entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that only the UEs subscribed to the service can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS), may refer to one reference signal or more than one reference signal.

Positioning reference signals (PRS) include downlink PRS (DL PRS) and uplink PRS (UL PRS) (which may be called SRS (Sounding Reference Signal) for positioning). PRS may comprise PRS resources or PRS resource sets of a frequency layer. A DL PRS positioning frequency layer (or simply a frequency layer) is a collection of DL PRS resource sets, from one or more TRPs, that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource, or simply resource can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple Resource Elements (REs) that may be in multiple Resource Blocks (RBs) within N (one or more) consecutive symbol(s) within a slot. An RB is a collection of REs spanning a quantity of one or more consecutive symbols in the time domain and a quantity (12 for a 5G RB) of consecutive subcarriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

Selective Positioning Signal Processing

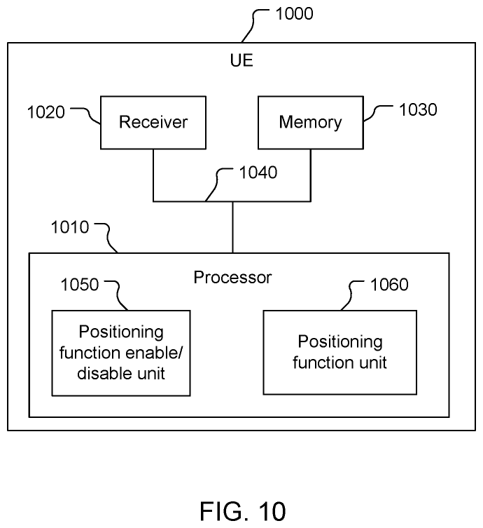

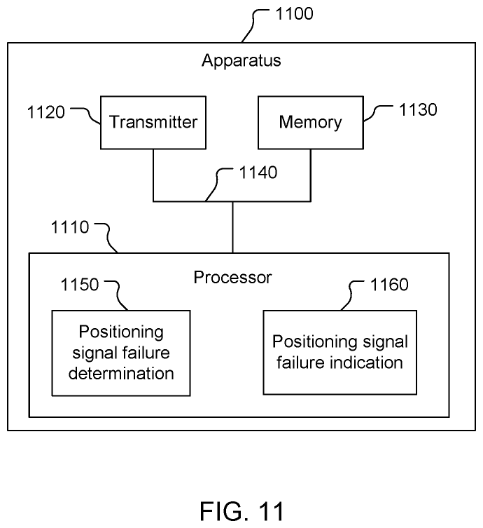

Referring also to FIG. 10, with further reference to FIGS. 1-4, a UE 1000 includes a processor 1010, a receiver 1020, and a memory 1030 communicatively coupled to each other by a bus 1040. The UE 1000 may include the components shown in FIG. 11, and may include one or more other components such as any of those shown in FIG. 2 such that the UE 200 may be an example of the UE 1000. For example, the processor 1010 may include one or more of the components of the processor 210. The receiver 1020 is configured to receive communication signals from a network entity such as the TRP 300 and/or the server 400 and to receive positioning signals (e.g., PRS from one or more network entities and/or one or more satellite signals from one or more SVs). For example, the receiver 1020 may include one or more of the wireless receiver 244 (and the antenna 246) and/or the wired receiver 254 and/or the SPS receiver 217 and the antenna 262. The UE 1000 may include a wireless transmitter (e.g., the wireless transmitter 242) and/or a wired transmitter such as the wired transmitter 252. The memory 1030 may be configured similarly to the memory 211, e.g., including software with processor-readable instructions configured to cause the processor 1010 to perform functions.

The description herein may refer only to the processor 1010 performing a function, but this includes other implementations such as where the processor 1010 executes software (stored in the memory 1030) and/or firmware. The description herein may refer to the UE 1000 performing a function as shorthand for one or more appropriate components (e.g., the processor 1010 and the memory 1030) of the UE 1000 performing the function. The processor 1010 (possibly in conjunction with the memory 1030 and, as appropriate, the receiver 1020) includes a positioning function enable/disable unit 1050 and a positioning function unit 1060. The positioning function enable/disable unit 1050 is configured to determine from one or more received signals indicative of one or more failures of a positioning signal source to determine one or more positioning functions (if any) to disable and to disable the determined positioning function(s), if any. The positioning function unit 1060 is configured to perform one or more positioning functions based on one or more positioning signals received by the receiver 1020 to determine position information (e.g., one or more measurements, one or more ranges (e.g., pseudoranges), one or more position estimates for the UE 1000, etc.). The positioning function enable/disable unit 1050 and the positioning function unit 1060 are discussed further below, and the description may refer to the processor 1010 generally, or the UE 1000 generally, as performing any of the functions of the positioning function enable/disable unit 1050 and/or the positioning function unit 1060.

Referring also to FIG. 11, with further reference to FIGS. 1-4, an apparatus 1100 includes a processor 1110, a transmitter 1120, and a memory 1130 communicatively coupled to each other by a bus 1140. The apparatus 1100 may include the components shown in FIG. 12, and may include one or more other components such as any of those shown in FIG. 3 and/or FIG. 4 such that the TRP 300 and/or the server 400 may be an example of the apparatus 1100. The transmitter 1120 may include one or more of the wireless transmitter 342 (and the antenna 346) and/or the wired transmitter 352 and/or the wireless transmitter 442 (and the antenna 446) and/or the wired transmitter 452. The transmitter 1120 is configured to transmit communication signals from to a network entity such as the TRP 300 and/or the server 400 and/or to a UE such as the UE 1000. The apparatus 1100 may include a receiver that is configured to receive positioning signals (e.g., PRS from one or more network entities and/or one or more satellite signals from one or more SVs). For example, the receiver may include one or more of the wireless receiver 344 and the antenna 346 and/or the wireless receiver 444 and the antenna 446 and/or an SPS receiver and corresponding antenna (e.g., the SPS receiver 317 and the antenna 362). The memory 1130 may be configured similarly to the memory 311 or the memory 411, e.g., including software with processor-readable instructions configured to cause the processor 1110 to perform functions.

The description herein may refer only to the processor 1110 performing a function, but this includes other implementations such as where the processor 1110 executes software (stored in the memory 1130) and/or firmware. The description herein may refer to the apparatus 1100 performing a function as shorthand for one or more appropriate components (e.g., the processor 1110 and the memory 1130) of the apparatus 1100 performing the function. The processor 1110 (possibly in conjunction with the memory 1130 and, as appropriate, the transmitter 1120) includes a positioning signal failure determination unit 1150 and a positioning signal failure indication unit 1160. The positioning signal failure determination unit 1150 is configured to determine whether a positioning-signal source has one or more failures, and determine one or more positioning signal functions that is(are) negatively affected by the failure(s). To determine whether the positioning-signal source has a failure, the positioning signal failure determination unit 1150 may receive one or more positioning signals from the positioning-signal source via a receiver of the apparatus 1100 and analyze the one or more positioning signals. Also or alternatively, the positioning signal failure determination unit 1150 may receive one or more indications of positioning signal source failure, e.g., via one or more communication signals received via the receiver of the apparatus 1100. The positioning signal failure indication unit 1160 is configured to send one or more indications of the failure(s) via the transmitter 1120 to the UE 1000, e.g., to cause the UE 1000 to disable one or more appropriate positioning-signal-processing functions. The positioning signal failure detection unit 1150 and the positioning signal failure indication unit 1160 are discussed further below, and the description may refer to the processor 1110 generally, or the apparatus 1100 generally, as performing any of the functions of the positioning signal failure detection unit 1150 and/or the positioning signal failure indication unit 1160.

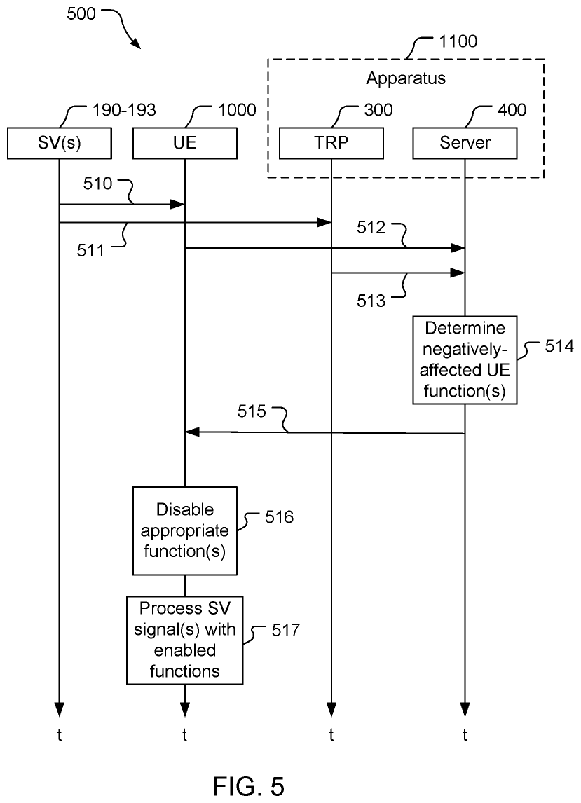

Referring also to FIG. 5, a process flow 500 is an example of signals sent between one or more of the SVs 190-193, the UE 1000 (e.g., the UE 200), the TRP 300, and the server 400 and processing of these signals to influence positioning signal processing by the UE 1000. The apparatus 1100 may include the TRP 300 and/or the server 400, or at least components of the TRP 300 and/or the server 400, e.g., the SPS receiver 317, although the discussion below discusses functionality of the TRP 300 and the server 400 separately. The SVs 190-193 are sources of positioning signals (i.e., signals that may be used to determine location, e.g., of the UE 1000). Other sources of positioning signals may be used instead of or in addition to the SVs 190-193 such as terrestrial base stations sending positioning signals, e.g., DL-PRS (downlink positioning reference signals). The TRP 300 may be used as a reference receiver to receive positioning signals and report to the server 400 information regarding the positioning signals (e.g., quality, absence of receipt of signal(s), information in a received signal, etc.). As discussed further below, the server 400 (or the TRP 300 or another device, alone or in conjunction with the server 400), e.g., the position signal failure indication unit 1160, may provide information to the UE 1000 regarding one or more of the positioning signal sources, here the SVs 190-193, to affect processing of positioning signals by the UE 1000. The UE 1000, e.g., the positioning function enable/disable unit 1050 and/or the positioning function unit 1060, may selectively process positioning signals, e.g., not process signals from a particular signal source, not process signals for particular information but process the signals for other information, etc.

Positioning signals may be sent by the positioning signal sources and received by the UE 1000 and the TRP 300. Here the SVs 190-193 may send SPS signals 510, 511 that the UE 1000 and the TRP 300 may receive, e.g., with the SPS receivers 217, 317. The SPS receivers 217, 317 may provide information regarding the received SPS signals to the processors 210, 310, respectively.

The SPS receivers 217, 317 and/or the processors 210, 310 and/or the positioning signal failure determination unit 1150 may be configured to detect a failure of SV 190-193 from one or more received SPS signals and/or from lack of receipt of an SPS signal. For example, the UE 1000 and/or the TRP 300 and/or the unit 1150 (e.g., from information (e.g., measurement(s) and/or failure indication(s)) provided by the TRP 300) may determine that data being sent from one or more of the SVs 190-193 is incorrect and/or stale and/or has poor Quality of Service (QoS). Stale SPS signal data are data that are older than a threshold amount of time after which the data are considered unreliable in that use of the data may result in an unacceptably inaccurate location determination. The SV signal data analyzed for SV failure may include time information (e.g., time of week and/or week number (e.g., in GPS systems) and/or day number (e.g., in GLO systems)), ephemeris information, almanac information, and/or satellite clock offset/drift information. The ephemeris information includes global parameters used to determine satellite position and almanac information includes a reduced set (compared to ephemeris) of global orbital parameters used to determine a coarse estimate of satellite position. The UE 1000 and/or the TRP 300 may employ Receiver Autonomous Integrity Monitoring (RAIM) techniques to detect failures. For example, the UE 1000 and/or the TRP 300 may determine whether a small set of SPS signal measurements is erroneous or not.

Various types of failures may be detected. For example, the SPS receivers 217, 317 and/or the processors 210, 310 and/or the positioning signal failure determination unit 1150 may be configured to detect satellite clock errors, ephemeris errors, continuous parity errors, stale/incorrect data, and/or user range accuracy failure. Satellite clock errors may be detected using RAIM/decoding of fresh data if available to obtain fresh clock information. Ephemeris errors (e.g., orbital prediction accuracy is unacceptable) may be detected by decoding fresh data/health information if available. Continuous parity failures may be detected by using a parity check algorithm. Stale and/or incorrect data (e.g., SVs in auto-navigation mode due to a communication outage between the SVs and ground stations) may be detected using consistency/comparison checks. User range accuracy being unacceptable may be detected by decoding current user range accuracy/RAIM.

The UE 1000 and/or the TRP 300 may send reporting communications 512, 513, respectively, to the server 400. The reporting communications 512, 513 may indicate the failure(s) of the corresponding SV(s) 190-193. Also or alternatively, the reporting communications 512, 513 may provide information (e.g., decoded data) from which the server 400 can determine the failure(s).

At block 514, the server 400, e.g., the positioning signal failure determination unit 1150, can process information from one or more of the reporting communications 512, 513 to determine one or more negatively-affected UE functions for processing positioning signals. The server 400 may determine one or more SV failures if the UE 1000 and/or the TRP 300 did not already do so (or may do so as a double check on the determination(s) by the UE 1000 and/or the TRP 300). The server 400 may use knowledge of the failure(s), e.g., what data are incorrect, stale, and/or otherwise of poor quality (e.g., user range accuracy outside of an acceptable limit), to determine which UE function(s) will be negatively affected, especially the UE function(s) that will be negatively affected enough that the function(s) should not be performed by the UE 1000, e.g., because doing so may waste energy and/or result in erroneous results (e.g., an unacceptably inaccurate location estimate being determined).

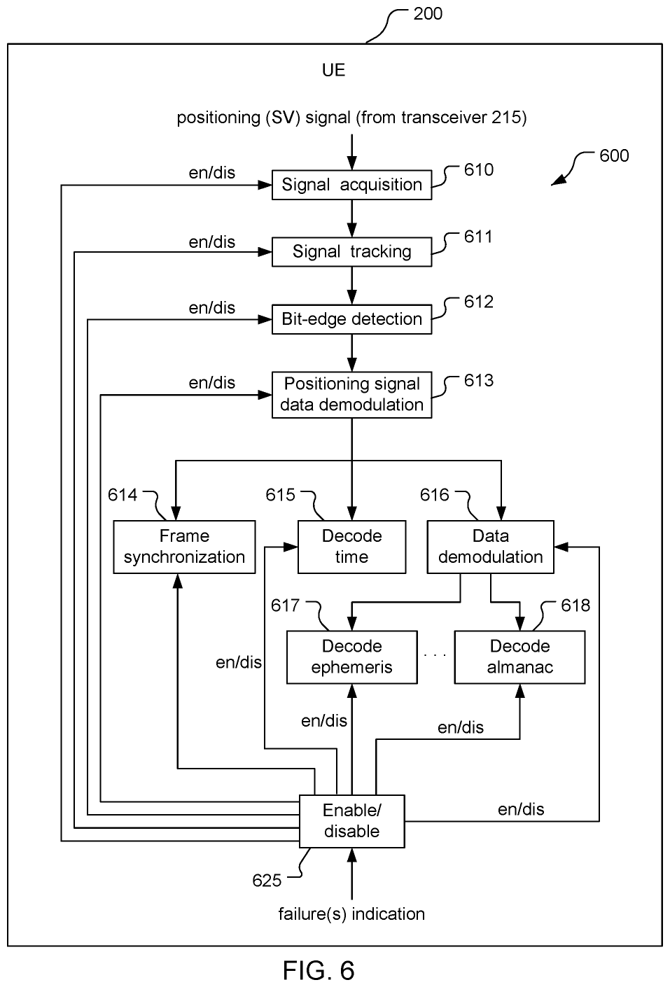

Referring also to FIG. 6, the UE 1000 may be configured to perform various operations on positioning signals. While the discussion of FIG. 6 may refer to SV signals and operations for SV signals, the discussion applies to other types of positioning signals. The receiver 1020 and/or the processor 1010 (possibly in combination with the memory 1030), e.g., the SPS receiver 217 or the processor 210 (e.g., the general-purpose/application processor 230, the DSP 231, and/or the modem processor 232), and the software 212 of the memory 211, in conjunction with the SPS receiver 217 may implement a signal acquisition function 610 for acquiring a positioning signal, e.g., an SV signal. The processor 1110, e.g., the general-purpose/application processor 230, the DSP 231, and/or the modem processor 232, possibly in conjunction with the software 212 of the memory 211, may implement a signal tracking function 611, a bit-edge detection function 612, a positioning signal data demodulation function 613, a frame synchronization function 614, a decode time function 615, and a data demodulation function 616. The data demodulation function 616 may include one or more functions such as a decode ephemeris function 617, a decode almanac function 618, and possibly one or more other functions (not shown). As shown, the functions 610-618 may be hierarchical (i.e., are parts of a hierarchy 600), such that a particular function lower on the hierarchy 600 relies on performance of any function(s) higher on the hierarchy 600 and in the same path in the hierarchy 600 as the particular function. Thus, if a selected function is disabled, then any function(s) lower on the hierarchy 600 and in a downstream path of the selected function, may be disabled as well (e.g., to save power). For example, if the function 612 is disabled, then functions 613-618 may be disabled. Conversely, if functions 610-613 are enabled, the decode time function 615 may be disabled but the frame synchronization function 614, the data demodulation function 616, the decode ephemeris function 617, and the decode almanac function 618 may be enabled. The processor 1010, the receiver 1020, and the memory 1030, e.g., processor 210, the memory 211, the transceiver 215 (e.g., the wireless receiver 244), and the transceiver interface 214 (and the SPS receiver 217 for an SV signal), may comprise means for acquiring the positioning signal, means for tracking the signal, means for bit-edge detection, means for positioning signal data demodulation, means for frame synchronization, means for data demodulation (e.g., means for decoding ephemeris data, means for decoding almanac data), and/or means for decoding time.

The apparatus 1100, e.g., the server 400, may determine whether any of the UE functions are negatively affected by the positioning signal source (e.g., SV) failure(s) and produce and send a failure communication 515 to the UE 1000 accordingly. While the discussion herein focuses on the UE functions, similar functions may be performed by the TRP 300 and the server 400 may send a failure communication to the TRP 300. The failure communication 515 corresponds to the SV failure(s) and may include one or more indications to cause the UE 1000 to take appropriate action (e.g., to disable one or more of the UE functions). For example, the failure communication 515 may indicate data issues (e.g., stale timing data, or inaccurate ephemeris data, etc.) that the UE 1000 can interpret to take appropriate action (e.g., to disable one or more functions). As another example, the failure communication 515 may include one or more instructions (i.e., commands) to disable one or more of the UE functions respectively. The failure communication 515 may indicate for which SV(s) a particular indication corresponds and may indicate an amount of time for which the UE 1000 should take appropriate action (e.g., an amount of time that the UE 1000 should disable a function).

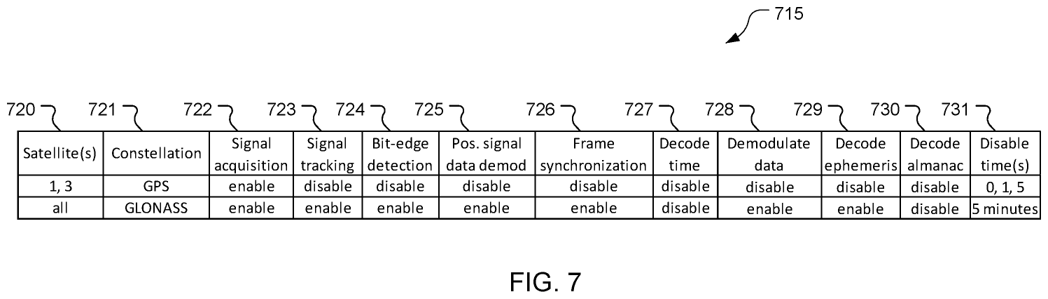

As shown in FIG. 7, an example failure communication 715 (which is an example of the failure communication 515) for satellite positioning signals includes a satellite ID field 720, a constellation ID field 721, a signal acquisition field 722, a signal tracking field 723, a bit-edge detection field 724, a positioning signal data demodulation field 725, a frame synchronization field 726, a decode time field 727, a demodulate data field 728, a decode ephemeris field 729, a decode almanac field 730, and a disable time(s) field 731. Numerous other examples of failure communications are possible, e.g., with one or more fields, such as one or more of the fields 729, 730, being omitted and/or including one or more other fields for one or more functions downstream from the data demodulation function 616. The satellite ID field 720 indicates for which SV(s) to apply the instructions in the fields 722-730. The constellation ID field 721 indicates for which positioning signal constellation the instructions apply. The constellation may be of one or more SVs and/or one or more terrestrial-based signal sources. The fields 722-730 contain instructions. Each of the instructions is a bit indicating whether the UE 1000 should disable or enable the corresponding function, here signal acquisition, signal tracking, bit-edge detection, positioning signal data demodulation, frame synchronization, decoding time from the signal(s), demodulating data from the signal(s), decoding ephemeris, and decoding almanac, respectively. As shown, the failure communication 715 may provide indications (e.g., commands) corresponding to failure(s) for more than one SV and/or more than one constellation of SVs. The failure communication 715 may indicate a subset of one or more SVs in a constellation to apply the corresponding instructions, or may indicate to apply the instructions to an entire constellation. The disable time(s) field 725 indicates one or more durations for which to disable the functions corresponding to the instructions. The field 725 may indicate an individual time for each of the instructions in the fields 722-724, or may indicate a time to apply to multiple instructions, e.g., all of the instructions. In the example shown, where the disable time(s) field indicates a single time value of 5 minutes, this will apply to all of the disabling instructions, thus instructing the UE 1000 to disable both decoding time and demodulating data for 5 minutes. Where multiple disable times are provided, the respective times are mapped to respective functions. The times shown are examples only, and numerous other time values may be used (e.g., seconds, hours, days, or even longer). A disable time value of 0 may be used for enabling instructions, or no disable time value may be provided for an enabling instruction. The disable time value may take a variety of forms, e.g., indicating one or more lengths of time to instruct the UE 1000 to disable the corresponding function(s) immediately for the length(s) of time, and/or indicating one or more time windows indicating a start time and an end time, or a start time and a time length. The disable time value (or even the disable time(s) field 725) may be omitted, and the failure communication 515 with an enable indication used to cause the UE 1000 to enable a previously-disabled function.

The example failure communication 715 illustrates hierarchical disabling of functions. In the communication 715, for satellites 1, 3 of the GPS constellation, the signal tracking field 723 indicates to disable the signal tracking function 611. Consequently, the fields 724-730 also indicate to disable the respective functions 612-618 as the functions 612-618 are all downstream of the function 611. For all satellites of the GLONASS constellation, only the decode almanac field 730 indicates to disable the corresponding decode almanac function 618, and thus the decode ephemeris field 729 may, as in this example, indicate to enable the decode ephemeris function 617 because the decode ephemeris function 617 is not downstream of the decode almanac function 618.

The apparatus 1100, e.g., the server 400, may be configured to send the failure communication 515 securely. For example, the server 400 may sign the failure communication 515 with a digital signature such that only authorized users, e.g., the UE 1000, are able to access the content of the failure communication 515. For example, the server 400 may send the failure communication 515 as part of one or more eXTended Receiver Assistance (XTRA) communications (e.g., gpsOneXTRA also known as IZat XTRA).

At block 516, the UE 1000 responds to the failure communication 515 by disabling the appropriate function(s). For example, the UE 1000 (e.g., the positioning function enable/disable unit 1050 such as the processor 210 and the memory 211) implements the enable/disable function 625 that analyzes the failure communication 515 and responds to the failure communication 515 by sending an enable/disable (en/dis) signal with a disable value to each of the functions 610-618 that should be disabled in view of the failure communication 515. The UE 1000 may send a respective enable/disable signal for each of the functions 610-618 or may send one or more enable/disable signals with at least one of such signals being for more than one of the functions 610-618. The UE 1000 may determine which function(s) to disable, e.g., by interpreting indications of data issues in the failure communication 515, or by reading the instructions in the fields 722-730. The enable/disable function 625 can disable the SV acquisition function 610 that is implemented by the SPS receiver 217 to acquire an SV signal. The enable/disable function 625 can disable the data demodulation function 615 that demodulates data (e.g., ephemeris information, almanac information, satellite clock offset/drift information) from SV signals. Even further granularity of data demodulation disabling may be provided, e.g., to disable decoding of one type of data (e.g., ephemeris) but not another (e.g., almanac, satellite clock offset/drift). The enable/disable function 625 can disable the decode time function 615 that decodes the time information in the SV signal. The enable/disable function 625 can disable any appropriate function for any appropriate SV (or other signal source), e.g., all the SVs indicated corresponding to a disable instruction. The enable/disable function 625 may disable functions for more SVs than indicated in the failure communication 515. For example, if a threshold number (e.g., raw number, percentage, etc.) of SVs of a constellation are indicated for disabling one or more functions, then the enable/disable function 625 may disable the indicated function(s) for all of the SVs in the constellation of the indicated SVs. The enable/disable function 625 may enable any of the functions 610-618, e.g., in response to the failure communication 515 or in response to a disable time expiring (e.g., a length of time passing or an end time occurring/passing) by sending the en/dis signal with an enable value.

The enable/disable function 625 provides granularity in function disabling at the UE 1000. Instead of disabling all functionality of signal processing for an SV signal from an SV in response to a health and/or integrity (e.g., if QoS is not met) indication for the SV, the enable/disable function 625 can disable one or more of the functions 610-618 while enabling (or at least not disabling) one or more other functions of the functions 610-618 (subject to hierarchical disabling as appropriate). Thus, for example, time data may be decoded from a signal from the SV 190 while ephemeris data from the same signal are not demodulated. Further, the enable/disable function 625 can disable one or more of the functions 610-618 for one or more of the SVs 190-193 while not disabling the same function(s) for the other SV(s) of the SVs 190-193. For example, the decode time function 615 may be disabled for the SVs 190, 191 and enabled for the SVs 192, 193 (and other SVs if the constellation has more than four SVs).

Referring again to FIG. 5, at block 517 the positioning function unit 1060 of the UE 1000 processes SV signals according to functions that are enabled. The UE 1000 is configured to process the incoming SV signals using any of the functions 610-618 that are enabled for the particular SV signals, e.g., from satellites for which one or more functions are enabled. Thus, the UE 1000 may process an SV signal according to at least one of the functions 610-618 while not processing the SV signal according to any of the functions 610-618 that is disabled.

Operation

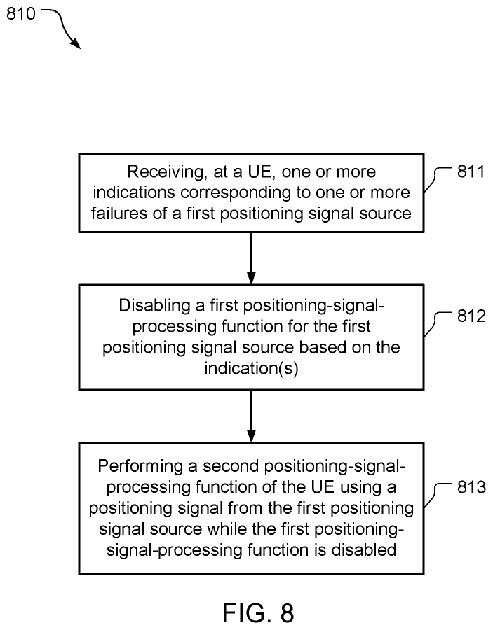

Referring to FIG. 8, with further reference to FIGS. 1-7, 10, and 11, a method 810 of controlling processing of positioning signals (e.g., satellite-vehicle signals) includes the stages shown. The method 810 is, however, an example only and not limiting. The method 810 may be altered, e.g., by having stages added, removed, rearranged, combined, performed concurrently, and/or having single stages split into multiple stages. For example, one or more stages may occur before, and/or one or more stages may occur after, the stages shown in FIG. 8. For example, positioning signals may be received and errors with the positioning signal sources reported, and determinations may be made (e.g., from the reported errors) as to what UE functions to disable before the stages shown. As another example, one or more disabled UE functions may be enabled, e.g., after the stages shown.

At stage 811, the method 810 includes receiving, at a UE, one or more indications corresponding to one or more failures of a first positioning signal source. For example, the UE 1000 receives the failure communication 515 that may indicate one or more failures (e.g., ephemeris data failure) for a particular SV or a set of SVs (e.g., some or all of a constellation of SVs) and/or may provide an instruction to disable one or more UE functions. The indication(s) may indicate that information sent by the particular SV is unreliable. This indication of unreliable data may be a direct indication (e.g., ephemeris data invalid, or almanac data stale) or an indirect indication (e.g., timing function of particular SV is failing). The receiver 1020, e.g., the receiver 244 of the wireless transceiver 240 and the antenna 246, may comprise means for receiving the one or more indications.

At stage 812, the method 810 includes disabling a first positioning-signal-processing function for the first positioning signal source. For example, the UE 1000 may respond to the failure communication by disabling one or more of the functions 610-618. For hierarchical functions, the UE 1000 may disable a function and, in conjunction with disabling that function, disable other (e.g., all other) functions that are downstream of (lower in the hierarchy, e.g., the hierarchy 600, and in a path including) the disabled function. For the example of the failure communication 715, the UE 1000 may respond to receiving the failure communication 715 by disabling the signal tracking function 611 for GPS satellites 1 and 3 for 1 and 5 minutes, respectively, and consequently disabling the functions 612-618 for these satellites because the functions 612-618 are all downstream of the signal tracking function 611. As another example, based on the failure communication 715, the UE 1000 may disable the decode time function 615 and the decode almanac function 618 for all satellites of the GLONASS constellation for 5 minutes without disabling any of the functions 610-614, 616, or 617. The UE 1000 may disable the appropriate function(s) for a limited amount of time, e.g., that is stored in the memory 211 or that is indicated in the failure communication. For example, the UE 1000 may disable the appropriate function(s) for a fixed amount of time from a start time, and enable the disabled function(s) after passage of the fixed amount of time from the start time. The processor 1010, e.g., the processor 210 (e.g., the general-purpose/application processor 230, the DSP 231, and/or the modem processor 232), possibly in conjunction with the memory 1030 (e.g., the memory 211 (e.g., the software 212)) may comprise means for disabling the first SV signal-processing function.

At stage 813, the method 810 includes performing a second positioning-signal-processing function of the UE using a positioning signal from the first positioning signal source while the first positioning-signal-processing function is disabled. For example, the UE 1000 may perform one or more of the functions 610-618 while one or more of the functions 610-618 even with or lower in the hierarchy 600 is(are) disabled (e.g., from processing the positioning signal). Continuing the example of the failure communication 715, the UE 1000 may acquire a satellite vehicle signal from satellites 1 and 3 in the GPS constellation, but not perform any of the functions 611-618 on the acquired satellite vehicle signal, and may perform all of the functions 610-618 on satellite vehicle signals from the GLONASS constellation except the decode time function 615 and the decode almanac function 618 for 5 minutes each. As another example, if the failure communication indicates a subset of positioning signal sources, then the UE 1000 may disable one or more positioning-signal-processing functions for the indicated subset, and thus not perform the disabled function(s) on the positioning signals from the subset, while performing one or more enabled positioning-signal-processing functions on the positioning signals from the subset. As another example, where the first and second positioning-signal-processing functions are part of a hierarchy of functions, the UE 1000 may disable positioning-signal-processing functions of the hierarchy that are lower in the hierarchy and in a common path of the first positioning-signal-processing function in conjunction with disabling the first positioning-signal-processing function. As another example, the method 810 may include disabling an indicated function from processing positioning signals from a first subset of positioning signal sources of a constellation in accordance with the failure communication, and processing positioning signals from a second subset of the positioning signal sources of the constellation according to the indicated function, where the first and second subsets are mutually exclusive (i.e., no positioning signal source in the first subset is in the second subset and vice versa). The UE may disable one or more functions for a (respective) fixed amount of time and enable the function(s) after passage of the (respective) amount of time. The processor 1010, e.g., the processor 210 (e.g., the general-purpose/application processor 230, the DSP 231, and/or the modem processor 232), possibly in conjunction with the memory 1030 (e.g., the memory 211 (e.g., the software 212)) may comprise means for processing the SV signal.

Implementations of the method 810 may include one or more of the following features. In an example implementation, the one or more indications comprise an instruction to disable the first positioning-signal-processing function for the first positioning signal source. In another example implementation, the one or more indications comprise an indication that information sent by the first positioning signal source is unreliable for use in the first positioning-signal-processing function. In another example implementation, the first positioning-signal-processing function of the UE and the second positioning-signal-processing function of the UE are part of a hierarchy of positioning-signal-processing functions, and the method comprises disabling positioning-signal-processing functions of the hierarchy that are lower in the hierarchy and in a common path of the first positioning-signal-processing function in conjunction with disabling the first positioning-signal-processing function. The processor 1010, e.g., the processor 210 (e.g., the general-purpose/application processor 230, the DSP 231, and/or the modem processor 232), possibly in conjunction with the memory 1030 (e.g., the memory 211 (e.g., the software 212)) may comprise means for disabling such positioning-signal-processing functions. In another example implementation, the one or more indications correspond to one or more failures of multiple positioning signal sources in a constellation of positioning signal sources, and disabling the first positioning-signal-processing function of the UE comprises disabling the first positioning-signal-processing function of the UE for all of the multiple positioning signal sources in the constellation of positioning signal sources.

Also or alternatively, implementations of the method 810 may include one or more of the following features. In an example implementation, the one or more indications correspond to one or more failures of a first plurality of positioning signal sources in a constellation of positioning signal sources, disabling the first positioning-signal-processing function of the UE for the first positioning signal source comprises disabling the first positioning-signal-processing function of the UE for the first plurality of positioning signal sources in the constellation of positioning signal sources, and the method comprises performing the first positioning-signal-processing function of the UE using positioning signals from a second plurality of positioning signal sources in the constellation of positioning signal sources, the first plurality of positioning signal sources and the second plurality of positioning signal sources being mutually exclusive. For example, processing of signals from some satellites that are failing may disabled but the same processing enabled for other satellites in the same constellation whose signals are not failing. In another example implementation, disabling the first positioning-signal-processing function of the UE for the first positioning signal source comprises disabling the first positioning-signal-processing function of the UE for the first positioning signal source for a fixed amount of time from a start time, the method further comprising enabling the first positioning-signal-processing function of the UE for the first positioning signal source after passage of the fixed amount of time from the start time. The processor 1110, possibly in conjunction with the memory 1130, may comprise means for enabling the first positioning-signal-processing function.

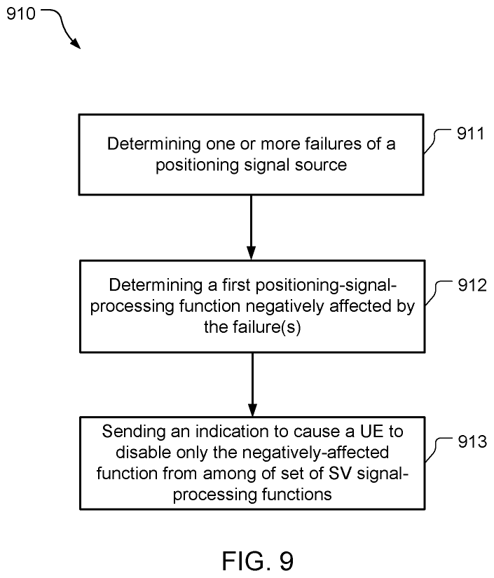

Referring to FIG. 9, with further reference to FIGS. 1-8, a method 910 of controlling processing of positioning signals (e.g., satellite-vehicle signals) includes the stages shown. The method 910 is, however, an example only and not limiting. The method 910 may be altered, e.g., by having stages added, removed, rearranged, combined, performed concurrently, and/or having single stages split into multiple stages. For example, one or more stages may occur before, and/or one or more stages may occur after, the stages shown in FIG. 9. For example, stages of the method 810 may be performed after the method 910.

At stage 911, the method 910 includes determining one or more failures of a positioning signal source. For example, the server 400 (or the TRP 300) may receive indications of SV signal problems (e.g., invalid or stale data) from one or more UEs, e.g., in the reporting communications 512, 513. As another example, the server 400 (or the TRP 300) may receive information from one or more UEs (or other sources) that the server 400 (or the TRP 300) may analyze to determine one or more SV failures (e.g., sending invalid or stale data, poor QoS of received signal(s), etc.). As another example, the TRP 300 may receive one or more SV signals and analyze the received SV signal(s) to determine the failure(s). The method 910, including stage 911, may be applied to positioning signals and positioning signal sources other than SV signals and SVs.

At stage 912, the method 910 includes determining a first positioning-signal-processing function, of a UE, negatively affected by the failure(s) of the positioning signal source. For example, the server 400 (or the TRP 300) may determine a function of the UE 1000 that will be negatively affected by the failure(s), with the UE 1000 configured to perform the first positioning-signal-processing function and a second positioning-signal-processing function. The server 400 (or the TRP 300) may analyze what the failure(s) is(are) and use a look-up table or other mapping of failures to positioning-signal-processing functions (e.g., the functions 610-618) to determine which function(s) will be negatively affected by the failure(s). Some failures may negatively affect a function but not rise to the level of the server 400 (or the TRP 300) affecting operation of the UE, e.g., if ephemeris data are not fresh (resulting in less-than possible, but acceptable, location determination accuracy), but not old enough to be considered stale (resulting in unacceptable location determination accuracy).

At stage 913, the method 910 includes sending an indication to the UE to cause the UE to disable only the first positioning-signal-processing function for the positioning signal source from among the first positioning-signal-processing function and the second positioning-signal-processing function. For example, the server 400 may send the failure communication 515 to the UE 1000 corresponding to the failure(s) which the UE 1000 can use to disable one or more appropriate functions (e.g., only the negatively-affected function(s)). The indication may not refer to the second positioning-signal-processing function. The indication may provide information (e.g., an instruction) to cause the UE 1000 to enable the second positioning-signal-processing function. The indication may indicate that information in the positioning signal (e.g., an SV signal) used for the first positioning-signal-processing function is invalid, or stale, or both. The indication may comprise an instruction for the UE 1000 to disable the first positioning-signal-processing function for the positioning signal source (e.g., an SV). The instruction may instruct the UE to disable more than one positioning-signal-processing function. For example, the first positioning-signal-processing function of the UE and the second positioning-signal-processing function of the UE may be part of a hierarchy of positioning-signal-processing functions, and the instruction may instruct the UE to disable positioning-signal-processing functions of the hierarchy that are lower in the hierarchy and in a common path of the first positioning-signal-processing function in conjunction with disabling the first positioning-signal-processing function. The instruction may instruct the UE to disable a positioning-signal-processing function for a subset of positioning signal sources in a constellation, with the subset having fewer than all of the positioning signal sources in the constellation, or to disable the positioning-signal-processing function for all positioning signal sources in a constellation. The instruction may instruct the UE to disable the first positioning-signal-processing function for a fixed amount of time from a start time (that the instruction may also indicate).

### Implementation Examples

Implementation examples are described in the following numbered clauses.

1. A user equipment (UE) comprising:

a memory;

a receiver configured to receive wireless signals; and

a processor communicatively coupled to the memory and the receiver and configured to:

receive, via the receiver, one or more indications corresponding to one or more failures of a first positioning signal source;

disable a first positioning-signal-processing function of the UE for the first positioning signal source based on the one or more indications; and

perform a second positioning-signal-processing function of the UE using a positioning signal from the first positioning signal source while the first positioning-signal-processing function of the UE is disabled.

2. The UE of clause 1, wherein the processor is configured to disable the first positioning-signal-processing function of the UE for the first positioning signal source in response to the one or more indications indicating that information in the positioning signal used for the first positioning-signal-processing function is invalid, or stale, or both.

3. The UE of clause 1, wherein the first positioning-signal-processing function of the UE and the second positioning-signal-processing function of the UE are part of a hierarchy of positioning-signal-processing functions, and wherein the processor is configured to disable positioning-signal-processing functions of the hierarchy that are lower in the hierarchy and in a common path of the first positioning-signal-processing function in conjunction with disabling the first positioning-signal-processing function.

4. The UE of clause 1, wherein the processor is configured to, in response to the one or more indications corresponding to one or more failures of multiple positioning signal sources in a constellation of positioning signal sources, disable the first positioning-signal-processing function of the UE for all of the multiple positioning signal sources in the constellation of positioning signal sources.

5. The UE of clause 1, wherein the processor is configured to, in response to the one or more indications corresponding to one or more failures of a first plurality of positioning signal sources in a constellation of positioning signal sources:

disable the first positioning-signal-processing function of the UE for the first plurality of positioning signal sources in the constellation of positioning signal sources; and

perform the first positioning-signal-processing function of the UE using positioning signals from a second plurality of positioning signal sources in the constellation of positioning signal sources, the first plurality of positioning signal sources and the second plurality of positioning signal sources being mutually exclusive.

6. The UE of clause 1, wherein the processor is configured to disable the first positioning-signal-processing function of the UE for the first positioning signal source for a fixed amount of time from a start time and to enable the first positioning-signal-processing function of the UE for the first positioning signal source after passage of the fixed amount of time from the start time.

7. The UE of clause 1, further comprising a transmitter communicatively coupled to the processor and configured to transmit wireless signals, wherein the processor is configured to determine a failure of a second positioning signal source based on a second satellite signal from the second positioning signal source, or lack of receipt of the second satellite signal, and to send an indication of the failure of the second positioning signal source to a base station, or a location server, or a combination thereof, via the transmitter.

8. The UE of clause 1, wherein:

the first positioning-signal-processing function comprises positioning signal data demodulation and the second positioning-signal-processing function comprises signal acquisition; or

the first positioning-signal-processing function comprises positioning signal data demodulation and the second positioning-signal-processing function comprises signal tracking; or

the first positioning-signal-processing function comprises decoding time and the second positioning-signal-processing function comprises data demodulation.

9. A method of controlling processing of positioning signals, the method comprising:

receiving, at a user equipment (UE), one or more indications corresponding to one or more failures of a first positioning signal source;

disabling a first positioning-signal-processing function of the UE for the first positioning signal source based on the one or more indications; and

performing a second positioning-signal-processing function of the UE using a positioning signal from the first positioning signal source while the first positioning-signal-processing function of the UE is disabled.

10. The method of clause 9, wherein the one or more indications comprise an instruction to disable the first positioning-signal-processing function for the first positioning signal source.

11. The method of clause 9, wherein the one or more indications comprise an indication that information sent by the first positioning signal source is unreliable for use in the first positioning-signal-processing function.

12. The method of clause 9, wherein the first positioning-signal-processing function of the UE and the second positioning-signal-processing function of the UE are part of a hierarchy of positioning-signal-processing functions, the method further comprising disabling positioning-signal-processing functions of the hierarchy that are lower in the hierarchy and in a common path of the first positioning-signal-processing function in conjunction with disabling the first positioning-signal-processing function.

13. The method of clause 9, wherein the one or more indications correspond to one or more failures of multiple positioning signal sources in a constellation of positioning signal sources, and disabling the first positioning-signal-processing function of the UE comprises disabling the first positioning-signal-processing function of the UE for all of the multiple positioning signal sources in the constellation of positioning signal sources.

14. The method of clause 9, wherein:

the one or more indications correspond to one or more failures of a first plurality of positioning signal sources in a constellation of positioning signal sources;

disabling the first positioning-signal-processing function of the UE for the first positioning signal source comprises disabling the first positioning-signal-processing function of the UE for the first plurality of positioning signal sources in the constellation of positioning signal sources; and

the method further comprises performing the first positioning-signal-processing function of the UE using positioning signals from a second plurality of positioning signal sources in the constellation of positioning signal sources, the first plurality of positioning signal sources and the second plurality of positioning signal sources being mutually exclusive.

15. The method of clause 9, wherein disabling the first positioning-signal-processing function of the UE for the first positioning signal source comprises disabling the first positioning-signal-processing function of the UE for the first positioning signal source for a fixed amount of time from a start time, the method further comprising enabling the first positioning-signal-processing function of the UE for the first positioning signal source after passage of the fixed amount of time from the start time.

16. A user equipment (UE) comprising:

means for receiving one or more indications corresponding to one or more failures of a first positioning signal source;

means for disabling a first positioning-signal-processing function of the UE for the first positioning signal source based on the one or more indications; and

means for performing a second positioning-signal-processing function of the UE using a positioning signal from the first positioning signal source while the first positioning-signal-processing function of the UE is disabled.

17. The UE of clause 16, wherein the means for disabling are for disabling the first positioning-signal-processing function of the UE for the first positioning signal source in response to the one or more indications indicating that information in the positioning signal used for the first positioning-signal-processing function is invalid, or stale, or both.

18. The UE of clause 16, wherein the first positioning-signal-processing function of the UE and the second positioning-signal-processing function of the UE are part of a hierarchy of positioning-signal-processing functions, and wherein the UE further comprises means for disabling positioning-signal-processing functions of the hierarchy that are lower in the hierarchy and in a common path of the first positioning-signal-processing function in conjunction with disabling the first positioning-signal-processing function.

19. The UE of clause 16, wherein the means for disabling are for responding to the one or more indications corresponding to one or more failures of multiple positioning signal sources in a constellation of positioning signal sources by disabling the first positioning-signal-processing function of the UE for all of the multiple positioning signal sources in the constellation of positioning signal sources.

20. The UE of clause 16, wherein:

the means for disabling are for responding to the one or more indications corresponding to one or more failures of a first plurality of positioning signal sources in a constellation of positioning signal sources by disabling the first positioning-signal-processing function of the UE for the first plurality of positioning signal sources in the constellation of positioning signal sources; and

the UE further comprises means for responding to the one or more indications corresponding to one or more failures of the first plurality of positioning signal sources in the constellation of positioning signal sources by performing the first positioning-signal-processing function using positioning signals from a second plurality of positioning signal sources in the constellation of positioning signal sources, the first plurality of positioning signal sources and the second plurality of positioning signal sources being mutually exclusive.

21. The UE of clause 16, wherein the means for disabling are for disabling the first positioning-signal-processing function of the UE for the first positioning signal source for a fixed amount of time from a start time, and wherein the UE further comprised means for enabling the first positioning-signal-processing function of the UE for the first positioning signal source after passage of the fixed amount of time from the start time.

22. The UE of clause 16, further comprising:

means for determining a failure of a second positioning signal source based on a second satellite signal from the second positioning signal source, or lack of receipt of the second satellite signal; and

means for sending an indication of the failure of the second positioning signal source to a base station, or a location server, or a combination thereof.

23. The UE of clause 16, wherein:

the first positioning-signal-processing function comprises positioning signal data demodulation and the second positioning-signal-processing function comprises signal acquisition; or

the first positioning-signal-processing function comprises positioning signal data demodulation and the second positioning-signal-processing function comprises signal tracking; or

the first positioning-signal-processing function comprises decoding time and the second positioning-signal-processing function comprises data demodulation.

24. A non-transitory processor-readable storage medium comprising processor-readable instructions configured to cause one or more processors of a user equipment (UE) to:

receive one or more indications corresponding to one or more failures of a first positioning signal source;

disable a first positioning-signal-processing function of the UE for the first positioning signal source based on the one or more indications; and

perform a second positioning-signal-processing function of the UE using a positioning signal from the first positioning signal source while the first positioning-signal-processing function of the UE is disabled.

25. The storage medium of clause 24, wherein the instructions comprise instructions configured to cause the one or more processors to disable the first positioning-signal-processing function of the UE for the first positioning signal source in response to the one or more indications indicating that information in the positioning signal used for the first positioning-signal-processing function is invalid, or stale, or both.

26. The storage medium of clause 24, wherein the first positioning-signal-processing function of the UE and the second positioning-signal-processing function of the UE are part of a hierarchy of positioning-signal-processing functions, and wherein the instructions comprise instructions configured to cause the one or more processors to disable positioning-signal-processing functions of the hierarchy that are lower in the hierarchy and in a common path of the first positioning-signal-processing function in conjunction with disabling the first positioning-signal-processing function.

27. The storage medium of clause 24, wherein the instructions comprise instructions configured to cause the one or more processors to, in response to the one or more indications corresponding to one or more failures of multiple positioning signal sources in a constellation of positioning signal sources, disable the first positioning-signal-processing function of the UE for all of the multiple positioning signal sources in the constellation of positioning signal sources.

28. The storage medium of clause 24, wherein the instructions comprise instructions configured to cause the one or more processors to, in response to the one or more indications corresponding to one or more failures of a first plurality of positioning signal sources in a constellation of positioning signal sources:

disable the first positioning-signal-processing function of the UE for the first plurality of positioning signal sources in the constellation of positioning signal sources; and

perform the first positioning-signal-processing function of the UE using positioning signals from a second plurality of positioning signal sources in the constellation of positioning signal sources, the first plurality of positioning signal sources and the second plurality of positioning signal sources being mutually exclusive.

29. The storage medium of clause 24, wherein the instructions comprise instructions configured to cause the one or more processors to disable the first positioning-signal-processing function of the UE for the first positioning signal source for a fixed amount of time from a start time and to enable the first positioning-signal-processing function of the UE for the first positioning signal source after passage of the fixed amount of time from the start time.

30. The storage medium of clause 24, wherein the instructions comprise instructions configured to cause the one or more processors to:

determine a failure of a second positioning signal source based on a second satellite signal from the second positioning signal source, or lack of receipt of the second satellite signal; and

send an indication of the failure of the second positioning signal source to a base station, or a location server, or a combination thereof.

31. An apparatus for controlling processing of positioning signals, the apparatus comprising:

a transmitter; and

a processor communicatively coupled to the transmitter and configured to:

determine one or more failures of a positioning signal source;

determine a first positioning-signal-processing function, of a user equipment (UE), negatively affected by the one or more failures of the positioning signal source, the UE being configured to perform the first positioning-signal-processing function and at least a second positioning-signal-processing function; and

send, via the transmitter, an indication to the UE to cause the UE to disable only the first positioning-signal-processing function for the positioning signal source from among the first positioning-signal-processing function and the second positioning-signal-processing function.

32. The apparatus of clause 31, wherein the indication indicates that information in a positioning signal used for the first positioning-signal-processing function is invalid, or stale, or both.

33. The apparatus of clause 31, wherein the indication comprises an instruction for the UE to disable the first positioning-signal-processing function for the positioning signal source.

34. The apparatus of clause 33, wherein the first positioning-signal-processing function of the UE and the second positioning-signal-processing function of the UE are part of a hierarchy of positioning-signal-processing functions, and wherein the instruction instructs the UE to disable positioning-signal-processing functions of the hierarchy that are lower in the hierarchy and in a common path of the first positioning-signal-processing function in conjunction with disabling the first positioning-signal-processing function.

35. The apparatus of clause 33, wherein the instruction instructs the UE to disable the first positioning-signal-processing function of the UE for a subset of positioning signal sources in a constellation of positioning signal sources, the subset of positioning signal sources containing fewer than all positioning signal sources in the constellation of positioning signal sources.

36. The apparatus of clause 33, wherein the instruction instructs the UE to disable the first positioning-signal-processing function of the UE for all positioning signal sources in a constellation of positioning signal sources.

37. The apparatus of clause 33, wherein the instruction instructs the UE to disable the first positioning-signal-processing function for the positioning signal source for a fixed amount of time from a start time.

38. The apparatus of clause 31, wherein:

the first positioning-signal-processing function comprises positioning signal data demodulation and the second positioning-signal-processing function comprises signal acquisition; or

the first positioning-signal-processing function comprises positioning signal data demodulation and the second positioning-signal-processing function comprises signal tracking; or

the first positioning-signal-processing function comprises decoding time and the second positioning-signal-processing function comprises data demodulation.

39. A method of controlling processing of positioning signals, the method comprising:

determining one or more failures of a positioning signal source;

determining a first positioning-signal-processing function, of a user equipment (UE), negatively affected by the one or more failures of the positioning signal source, the UE being configured to perform the first positioning-signal-processing function and at least a second positioning-signal-processing function; and

sending an indication to the UE to cause the UE to disable only the first positioning-signal-processing function for the positioning signal source from among the first positioning-signal-processing function and the second positioning-signal-processing function.

40. The method of clause 39, wherein the indication indicates that information in a positioning signal used for the first positioning-signal-processing function is invalid, or stale, or both.

41. The method of clause 39, wherein the indication comprises an instruction for the UE to disable the first positioning-signal-processing function for the positioning signal source.

42. The method of clause 41, wherein the first positioning-signal-processing function of the UE and the second positioning-signal-processing function of the UE are part of a hierarchy of positioning-signal-processing functions, and wherein the instruction instructs the UE to disable positioning-signal-processing functions of the hierarchy that are lower in the hierarchy and in a common path of the first positioning-signal-processing function in conjunction with disabling the first positioning-signal-processing function.

43. The method of clause 41, wherein the instruction instructs the UE to disable the first positioning-signal-processing function of the UE for a subset of positioning signal sources in a constellation of positioning signal sources, the subset of positioning signal sources containing fewer than all positioning signal sources in the constellation of positioning signal sources.

44. The method of clause 41, wherein the instruction instructs the UE to disable the first positioning-signal-processing function of the UE for all positioning signal sources in a constellation of positioning signal sources.

45. The method of clause 41, wherein the instruction instructs the UE to disable the first positioning-signal-processing function for the positioning signal source for a fixed amount of time from a start time.

46. An apparatus for controlling processing of positioning signals, the apparatus comprising:

means for determining one or more failures of a positioning signal source;

means for determining a first positioning-signal-processing function, of a user equipment (UE), negatively affected by the one or more failures of the positioning signal source, the UE being configured to perform the first positioning-signal-processing function and at least a second positioning-signal-processing function; and

means for sending an indication to the UE to cause the UE to disable only the first positioning-signal-processing function for the positioning signal source from among the first positioning-signal-processing function and the second positioning-signal-processing function.

47. The apparatus of clause 46, wherein the indication indicates that information in a positioning signal used for the first positioning-signal-processing function is invalid, or stale, or both.

48. The apparatus of clause 46, wherein the indication comprises an instruction for the UE to disable the first positioning-signal-processing function for the positioning signal source.

49. The apparatus of clause 48, wherein the first positioning-signal-processing function of the UE and the second positioning-signal-processing function of the UE are part of a hierarchy of positioning-signal-processing functions, and wherein the instruction instructs the UE to disable positioning-signal-processing functions of the hierarchy that are lower in the hierarchy and in a common path of the first positioning-signal-processing function in conjunction with disabling the first positioning-signal-processing function.

50. The apparatus of clause 48, wherein the instruction instructs the UE to disable the first positioning-signal-processing function of the UE for a subset of positioning signal sources in a constellation of positioning signal sources, the subset of positioning signal sources containing fewer than all positioning signal sources in the constellation of positioning signal sources.

51. The apparatus of clause 48, wherein the instruction instructs the UE to disable the first positioning-signal-processing function of the UE for all positioning signal sources in a constellation of positioning signal sources.

52. The apparatus of clause 48, wherein the instruction instructs the UE to disable the first positioning-signal-processing function for the positioning signal source for a fixed amount of time from a start time.

53. The apparatus of clause 46, wherein:

the first positioning-signal-processing function comprises positioning signal data demodulation and the second positioning-signal-processing function comprises signal acquisition; or

the first positioning-signal-processing function comprises positioning signal data demodulation and the second positioning-signal-processing function comprises signal tracking; or

the first positioning-signal-processing function comprises decoding time and the second positioning-signal-processing function comprises data demodulation.

54. A non-transitory processor-readable storage medium comprising processor-readable instructions configured to cause one or more processors to:

determine one or more failures of a positioning signal source;

determine a first positioning-signal-processing function, of a user equipment (UE), negatively affected by the one or more failures of the positioning signal source, the UE being configured to perform the first positioning-signal-processing function and at least a second positioning-signal-processing function; and

send an indication to the UE to cause the UE to disable only the first positioning-signal-processing function for the positioning signal source from among the first positioning-signal-processing function and the second positioning-signal-processing function.

55. The storage medium of clause 54, wherein the indication indicates that information in a positioning signal used for the first positioning-signal-processing function is invalid, or stale, or both.

56. The storage medium of clause 54, wherein the indication comprises an instruction for the UE to disable the first positioning-signal-processing function for the positioning signal source.

57. The storage medium of clause 56, wherein the first positioning-signal-processing function of the UE and the second positioning-signal-processing function of the UE are part of a hierarchy of positioning-signal-processing functions, and wherein the instruction instructs the UE to disable positioning-signal-processing functions of the hierarchy that are lower in the hierarchy and in a common path of the first positioning-signal-processing function in conjunction with disabling the first positioning-signal-processing function.

58. The storage medium of clause 56, wherein the instruction instructs the UE to disable the first positioning-signal-processing function of the UE for a subset of positioning signal sources in a constellation of positioning signal sources, the subset of positioning signal sources containing fewer than all positioning signal sources in the constellation of positioning signal sources.

59. The storage medium of clause 56, wherein the instruction instructs the UE to disable the first positioning-signal-processing function of the UE for all positioning signal sources in a constellation of positioning signal sources.

60. The storage medium of clause 56, wherein the instruction instructs the UE to disable the first positioning-signal-processing function for the positioning signal source for a fixed amount of time from a start time.

Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. For example, one or more functions, or one or more portions thereof, discussed above as occurring in the server 120 may be performed outside of the server 120 such as by the TRP 300.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, the term RS (reference signal) may refer to one or more reference signals and may apply, as appropriate, to any form of the term RS, e.g., PRS, SRS, CSI-RS, etc.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment (UE) comprising:
a memory;
a receiver configured to receive wireless signals; and
a processor communicatively coupled to the memory and the receiver and configured to:
receive, via the receiver, one or more indications corresponding to one or more failures of a first positioning signal source;
disable a first positioning-signal-processing function of the UE for the first positioning signal source based on the one or more indications; and
perform a second positioning-signal-processing function of the UE using a positioning signal from the first positioning signal source while the first positioning-signal-processing function of the UE is disabled.

2. The UE of claim 1, wherein the processor is configured to disable the first positioning-signal-processing function of the UE for the first positioning signal source in response to the one or more indications indicating that information in the positioning signal used for the first positioning-signal-processing function is invalid, or stale, or both.

3. The UE of claim 1, wherein the first positioning-signal-processing function of the UE and the second positioning-signal-processing function of the UE are part of a hierarchy of positioning-signal-processing functions, and wherein the processor is configured to disable positioning-signal-processing functions of the hierarchy that are lower in the hierarchy and in a common path of the first positioning-signal-processing function in conjunction with disabling the first positioning-signal-processing function.

4. The UE of claim 1, wherein the processor is configured to, in response to the one or more indications corresponding to one or more failures of multiple positioning signal sources in a constellation of positioning signal sources, disable the first positioning-signal-processing function of the UE for all of the multiple positioning signal sources in the constellation of positioning signal sources.

5. The UE of claim 1, wherein the processor is configured to, in response to the one or more indications corresponding to one or more failures of a first plurality of positioning signal sources in a constellation of positioning signal sources:
disable the first positioning-signal-processing function of the UE for the first plurality of positioning signal sources in the constellation of positioning signal sources; and
perform the first positioning-signal-processing function of the UE using positioning signals from a second plurality of positioning signal sources in the constellation of positioning signal sources, the first plurality of positioning signal sources and the second plurality of positioning signal sources being mutually exclusive.

6. The UE of claim 1, wherein the processor is configured to disable the first positioning-signal-processing function of the UE for the first positioning signal source for a fixed amount of time from a start time and to enable the first positioning-signal-processing function of the UE for the first positioning signal source after passage of the fixed amount of time from the start time.

7. The UE of claim 1, further comprising a transmitter communicatively coupled to the processor and configured to transmit wireless signals, wherein the processor is configured to determine a failure of a second positioning signal source based on a second satellite signal from the second positioning signal source, or lack of receipt of the second satellite signal, and to send an indication of the failure of the second positioning signal source to a base station, or a location server, or a combination thereof, via the transmitter.

8. The UE of claim 1, wherein:
the first positioning-signal-processing function comprises positioning signal data demodulation and the second positioning-signal-processing function comprises signal acquisition; or
the first positioning-signal-processing function comprises positioning signal data demodulation and the second positioning-signal-processing function comprises signal tracking; or
the first positioning-signal-processing function comprises decoding time and the second positioning-signal-processing function comprises data demodulation.

9. A method of controlling processing of positioning signals, the method comprising:
receiving, at a user equipment (UE), one or more indications corresponding to one or more failures of a first positioning signal source;
disabling a first positioning-signal-processing function of the UE for the first positioning signal source based on the one or more indications; and
performing a second positioning-signal-processing function of the UE using a positioning signal from the first positioning signal source while the first positioning-signal-processing function of the UE is disabled.

10. The method of claim 9, wherein the one or more indications comprise an instruction to disable the first positioning-signal-processing function for the first positioning signal source.

11. The method of claim 9, wherein the one or more indications comprise an indication that information sent by the first positioning signal source is unreliable for use in the first positioning-signal-processing function.

12. The method of claim 9, wherein the first positioning-signal-processing function of the UE and the second positioning-signal-processing function of the UE are part of a hierarchy of positioning-signal-processing functions, the method further comprising disabling positioning-signal-processing functions of the hierarchy that are lower in the hierarchy and in a common path of the first positioning-signal-processing function in conjunction with disabling the first positioning-signal-processing function.

13. The method of claim 9, wherein the one or more indications correspond to one or more failures of multiple positioning signal sources in a constellation of positioning signal sources, and disabling the first positioning-signal-processing function of the UE comprises disabling the first positioning-signal-processing function of the UE for all of the multiple positioning signal sources in the constellation of positioning signal sources.

14. The method of claim 9, wherein:
the one or more indications correspond to one or more failures of a first plurality of positioning signal sources in a constellation of positioning signal sources;
disabling the first positioning-signal-processing function of the UE for the first positioning signal source comprises disabling the first positioning-signal-processing function of the UE for the first plurality of positioning signal sources in the constellation of positioning signal sources; and
the method further comprises performing the first positioning-signal-processing function of the UE using positioning signals from a second plurality of positioning signal sources in the constellation of positioning signal sources, the first plurality of positioning signal sources and the second plurality of positioning signal sources being mutually exclusive.

15. The method of claim 9, wherein disabling the first positioning-signal-processing function of the UE for the first positioning signal source comprises disabling the first positioning-signal-processing function of the UE for the first positioning signal source for a fixed amount of time from a start time, the method further comprising enabling the first positioning-signal-processing function of the UE for the first positioning signal source after passage of the fixed amount of time from the start time.

16. A user equipment (UE) comprising:
means for receiving one or more indications corresponding to one or more failures of a first positioning signal source;
means for disabling a first positioning-signal-processing function of the UE for the first positioning signal source based on the one or more indications; and
means for performing a second positioning-signal-processing function of the UE using a positioning signal from the first positioning signal source while the first positioning-signal-processing function of the UE is disabled.

17. The UE of claim 16, wherein the means for disabling are for disabling the first positioning-signal-processing function of the UE for the first positioning signal source in response to the one or more indications indicating that information in the positioning signal used for the first positioning-signal-processing function is invalid, or stale, or both.

18. The UE of claim 16, wherein the first positioning-signal-processing function of the UE and the second positioning-signal-processing function of the UE are part of a hierarchy of positioning-signal-processing functions, and wherein the UE further comprises means for disabling positioning-signal-processing functions of the hierarchy that are lower in the hierarchy and in a common path of the first positioning-signal-processing function in conjunction with disabling the first positioning-signal-processing function.

19. The UE of claim 16, wherein the means for disabling are for responding to the one or more indications corresponding to one or more failures of multiple positioning signal sources in a constellation of positioning signal sources by disabling the first positioning-signal-processing function of the UE for all of the multiple positioning signal sources in the constellation of positioning signal sources.

20. The UE of claim 16, wherein:
the means for disabling are for responding to the one or more indications corresponding to one or more failures of a first plurality of positioning signal sources in a constellation of positioning signal sources by disabling the first positioning-signal-processing function of the UE for the first plurality of positioning signal sources in the constellation of positioning signal sources; and
the UE further comprises means for responding to the one or more indications corresponding to one or more failures of the first plurality of positioning signal sources in the constellation of positioning signal sources by performing the first positioning-signal-processing function using positioning signals from a second plurality of positioning signal sources in the constellation of positioning signal sources, the first plurality of positioning signal sources and the second plurality of positioning signal sources being mutually exclusive.

21. The UE of claim 16, wherein the means for disabling are for disabling the first positioning-signal-processing function of the UE for the first positioning signal source for a fixed amount of time from a start time, and wherein the UE further comprised means for enabling the first positioning-signal-processing function of the UE for the first positioning signal source after passage of the fixed amount of time from the start time.

22. The UE of claim 16, further comprising:
means for determining a failure of a second positioning signal source based on a second satellite signal from the second positioning signal source, or lack of receipt of the second satellite signal; and
means for sending an indication of the failure of the second positioning signal source to a base station, or a location server, or a combination thereof.

23. The UE of claim 16, wherein:
the first positioning-signal-processing function comprises positioning signal data demodulation and the second positioning-signal-processing function comprises signal acquisition; or
the first positioning-signal-processing function comprises positioning signal data demodulation and the second positioning-signal-processing function comprises signal tracking; or
the first positioning-signal-processing function comprises decoding time and the second positioning-signal-processing function comprises data demodulation.

24. An apparatus for controlling processing of positioning signals, the apparatus comprising:
a transmitter; and
a processor communicatively coupled to the transmitter and configured to:
determine one or more failures of a positioning signal source;
determine a first positioning-signal-processing function, of a user equipment (UE), negatively affected by the one or more failures of the positioning signal source, the UE being configured to perform the first positioning-signal-processing function and at least a second positioning-signal-processing function; and
send, via the transmitter, an indication to the UE to cause the UE to disable only the first positioning-signal-processing function for the positioning signal source from among the first positioning-signal-processing function and the second positioning-signal-processing function.

25. The apparatus of claim 24, wherein the indication indicates that information in a positioning signal used for the first positioning-signal-processing function is invalid, or stale, or both.

26. The apparatus of claim 24, wherein the indication comprises an instruction for the UE to disable the first positioning-signal-processing function for the positioning signal source.

27. The apparatus of claim 26, wherein the first positioning-signal-processing function of the UE and the second positioning-signal-processing function of the UE are part of a hierarchy of positioning-signal-processing functions, and wherein the instruction instructs the UE to disable positioning-signal-processing functions of the hierarchy that are lower in the hierarchy and in a common path of the first positioning-signal-processing function in conjunction with disabling the first positioning-signal-processing function.

28. The apparatus of claim 26, wherein the instruction instructs the UE to disable the first positioning-signal-processing function of the UE for a subset of positioning signal sources in a constellation of positioning signal sources, the subset of positioning signal sources containing fewer than all positioning signal sources in the constellation of positioning signal sources.

29. The apparatus of claim 26, wherein the instruction instructs the UE to disable the first positioning-signal-processing function of the UE for all positioning signal sources in a constellation of positioning signal sources.

30. The apparatus of claim 26, wherein the instruction instructs the UE to disable the first positioning-signal-processing function for the positioning signal source for a fixed amount of time from a start time.

31. The apparatus of claim 24, wherein:
the first positioning-signal-processing function comprises positioning signal data demodulation and the second positioning-signal-processing function comprises signal acquisition; or
the first positioning-signal-processing function comprises positioning signal data demodulation and the second positioning-signal-processing function comprises signal tracking; or
the first positioning-signal-processing function comprises decoding time and the second positioning-signal-processing function comprises data demodulation.

32. A method of controlling processing of positioning signals, the method comprising:
determining one or more failures of a positioning signal source;
determining a first positioning-signal-processing function, of a user equipment (UE), negatively affected by the one or more failures of the positioning signal source, the UE being configured to perform the first positioning-signal-processing function and at least a second positioning-signal-processing function; and
sending an indication to the UE to cause the UE to disable only the first positioning-signal-processing function for the positioning signal source from among the first positioning-signal-processing function and the second positioning-signal-processing function.

33. The method of claim 32, wherein the indication indicates that information in a positioning signal used for the first positioning-signal-processing function is invalid, or stale, or both.

34. The method of claim 32, wherein the indication comprises an instruction for the UE to disable the first positioning-signal-processing function for the positioning signal source.

35. The method of claim 34, wherein the first positioning-signal-processing function of the UE and the second positioning-signal-processing function of the UE are part of a hierarchy of positioning-signal-processing functions, and wherein the instruction instructs the UE to disable positioning-signal-processing functions of the hierarchy that are lower in the hierarchy and in a common path of the first positioning-signal-processing function in conjunction with disabling the first positioning-signal-processing function.

36. The method of claim 34, wherein the instruction instructs the UE to disable the first positioning-signal-processing function of the UE for a subset of positioning signal sources in a constellation of positioning signal sources, the subset of positioning signal sources containing fewer than all positioning signal sources in the constellation of positioning signal sources.

37. The method of claim 34, wherein the instruction instructs the UE to disable the first positioning-signal-processing function of the UE for all positioning signal sources in a constellation of positioning signal sources.

38. The method of claim 34, wherein the instruction instructs the UE to disable the first positioning-signal-processing function for the positioning signal source for a fixed amount of time from a start time.

39. An apparatus for controlling processing of positioning signals, the apparatus comprising:
means for determining one or more failures of a positioning signal source;
means for determining a first positioning-signal-processing function, of a user equipment (UE), negatively affected by the one or more failures of the positioning signal source, the UE being configured to perform the first positioning-signal-processing function and at least a second positioning-signal-processing function; and
means for sending an indication to the UE to cause the UE to disable only the first positioning-signal-processing function for the positioning signal source from among the first positioning-signal-processing function and the second positioning-signal-processing function.

40. The apparatus of claim 39, wherein the indication indicates that information in a positioning signal used for the first positioning-signal-processing function is invalid, or stale, or both.

41. The apparatus of claim 39, wherein the indication comprises an instruction for the UE to disable the first positioning-signal-processing function for the positioning signal source.

42. The apparatus of claim 41, wherein the first positioning-signal-processing function of the UE and the second positioning-signal-processing function of the UE are part of a hierarchy of positioning-signal-processing functions, and wherein the instruction instructs the UE to disable positioning-signal-processing functions of the hierarchy that are lower in the hierarchy and in a common path of the first positioning-signal-processing function in conjunction with disabling the first positioning-signal-processing function.

43. The apparatus of claim 41, wherein the instruction instructs the UE to disable the first positioning-signal-processing function of the UE for a subset of positioning signal sources in a constellation of positioning signal sources, the subset of positioning signal sources containing fewer than all positioning signal sources in the constellation of positioning signal sources.

44. The apparatus of claim 41, wherein the instruction instructs the UE to disable the first positioning-signal-processing function of the UE for all positioning signal sources in a constellation of positioning signal sources.

45. The apparatus of claim 41, wherein the instruction instructs the UE to disable the first positioning-signal-processing function for the positioning signal source for a fixed amount of time from a start time.

46. The apparatus of claim 39, wherein:
the first positioning-signal-processing function comprises positioning signal data demodulation and the second positioning-signal-processing function comprises signal acquisition; or
the first positioning-signal-processing function comprises positioning signal data demodulation and the second positioning-signal-processing function comprises signal tracking; or
the first positioning-signal-processing function comprises decoding time and the second positioning-signal-processing function comprises data demodulation.
